(19) United States
(12) Patent Application Publication
(10) Pub. No.: US 2018/0235844 A1
(43) Pub. Date: Aug. 23, 2018

(54) Sippy Cap Hygienic Replacement Bottle Cap

(71) Applicant: Jake Evans, Charlotte, NC (US)

(72) Inventors: Matt Cox, Franklin, TN (US); Jake Evans, Charlotte, NC (US)

(21) Appl. No.: 15/441,206

(22) Filed: Feb. 23, 2017

(51) Int. Cl. A61J 11/04; A47G 19/22; B65D 41/26

(52) U.S. Cl. CPC A61J 11/045; B65D 41/26; A47G 19/2272

(57) ABSTRACT

A hygienic bottle cap to replace the standard sized, standard designed cap or bottle top commonly found on plastic bottles and adapt the opening for use with kids spouts such as sippy cup spouts, nipples, straws and the like while providing flow control/spill resistance.

### BACKGROUND OF THE INVENTION

In the art of interfacing users with bottles to facilitate drinking there are many options. The simplest is the use of the bottle opening when the cap is removed. This simplest option, however, is not always fully effective. Consider infants and children who have not developed the necessary motor skills to drink from a bottle. Consider adult users who are otherwise using their eyes and hands. This invention is focused on the needs of these users. This invention provides alternatives to the simplest option and the other options that are currently available in the marketplace.

The specific problems with prior art solutions is the difficulty with cleaning the products and the higher skill levels that are required to use the open bottle. Prior art solutions include patented options such as U.S. Pat. No. 7,931,166, which discloses a container cap with two openings. U.S. Pat. No. 6,877,626 discloses a spill proof cap. U.S. Pat. No. 7,661,546 discloses a switch cap for drinking a bottle. U.S. Pat. No. 7,481,324 discloses a nipple adapter for beverage bottles. Each of these examples results in a design having internal corners that trap molecules of the liquid and result in mildewing inside the device. Particularly in the case of children, it is entirely unacceptable for a nipple or spout to harbor mildew.

### BRIEF SUMMARY OF THE INVENTION

The mildew problem with prior art bottle spouts and adapters is specifically overcome in a number of ways including the use of designs that eliminate the hidden internal corners; particularly during cleaning. Ease of use is increased by using spouts and adapters. This functionality is further enabled by the use of materials that increase flexibility and sealing ability.

### DETAILED DESCRIPTION OF THE INVENTION

The present invention is a bottle spout assembly, and has two central aspects that are presented in a variety of embodiments. The first aspect disclosed herein relates to the details necessary for the invention to fit onto standard bottle openings. The second aspect disclosed herein relates to the details necessary for the invention to be hygienic—meaning readily cleaned and resistant to the growth of mold, mildew and similar. These two aspects are “embodied” in a number of examples.

The size of the bottle spout herein disclosed is specific to its application. The present invention includes adapters and spouts that are designed to work with standard sized plastic drink bottles. The invention utilizes details that attach to the bottle, seal the attachment point, introduce an opening for a flow, provide one or more of a drinking detail, and provide a flow control detail to reduce spillage. Such bottes having an approximately 28 mm opening, often found on plastic containers such as:
8 oz. and 16 oz. water bottles
10, 16 and 20 ounce soda bottles
2 liter bottles

Though the invention can be sized to fit other bottle openings.

The size of the spout and the size of the standard bottle opening permit a high flow. This device has a user-focus on children's and on adult exercise. These users require a controlled flow. An exemplary embodiment of flow control that can be used in this spout is a duckbill valve, a second example is a single linear slit cut through an adapter, a third example uses double and crosscut linear slits cut through an adapter, a fourth example uses molded details around slits to further control flow; and a fifth example uses multiple linear slits.

The fit of the spout to the bottle is also a key feature of the invention. That is, the spout must fit the opening in a usable but robust manner. The spout is usable in that it can be pressed or screwed onto the bottle opening manually. The force to press on should be ergonomically appropriate, such that an adult can press it on firmly, a child is not readily able to remove it and it maintains its hold on the bottle opening during use. A second embodiment uses an internally threaded body that is screwed onto the bottle opening by a user, as is familiar in the art.

Hygienic is the second aspect of the bottle spout herein disclosed, and there are two features that enable this aspect. That includes the shape of the spout and the selection of materials. Functionally, the preventing unwanted growth such as mold and mildew is accommodated with materials. Being a drinking device, particularly for use with children, reducing mildew is an important design feature.

The shape of the spout specifically requires that all internal corners have a large radius. Injection molding typically requires a corner of a molded product to be limited to 0.25T to 0.6 T (T=Thickness, of the material in the general location of the corner or edge). This standard achieves a repeatable, good quality release from the mold and assures adequate flow of the molding material to all parts of the product. The exemplary embodiments herein disclosed require all internal corners to have a radius greater than what is required by injection molding quality standards, since that value is a variable based on the Thickness of materials used, in this disclosure 0.75T is used as an exemplary value.

In this disclosure, the invention is enabled in a variety of embodiments. To discuss enablement details of each embodiment, nonlimiting examples are provided. Each of the embodiments of the invention disclosed herein can be screwed onto a threaded bottle opening. Some can be manually pressed over the threads. Either will have details to retain to the embodiment to the bottle opening that are either interference fits or threaded.

In this disclosure certain terms are used with specific meanings. Adapters are devices that fit over the top of a bottle, and then receive a spout. Adapters can be used without the spout by squeezing the bottle. Adapters physically secure to the bottle opening and can be threaded or secured with an interference fit. Spouts physically contact the user's mouth and are any of the type including but not limited to flip up spouts, straws, bottle nipples, baby nipples, wide spouts, twist to open spouts, and others having a generally hollow design that allows fluid to pass from the bottle and generally to the user. Adapters and spouts also generally include the use of flow controls such as slits in a flexible stopper or one way valves to restrict flow out of the bottle until such a valve is deliberately opened by the user.

In some embodiments, an invertible nipple is discussed. The invertible nipple uses a flexible material such as rubber or a soft polymer. A detail of the nipple is that when the nipple is inverted, any sharp corners that are made by the nipple in an extended position are exposed by the inversion; furthermore, sharp corners are not created by the inversion such that the internal surface of the device is more readily cleaned.

In an embodiment, the materials used in the device are made with materials impregnated with substances that reduce the propensity to grow contaminants. As an example these substances include antimicrobial, antibacterial, and disinfecting substances.

In an embodiment, the adapter and spout are designed to reuse the cap. The invention is screwed onto the bottle opening. As an example, the invention includes a nipple made of flexible material that is designed to have two functional states; a rigid plastic section having internal threads to fit on a bottle and external threads to receive the original bottle cap. The nipple is intended to hold its position in each of the two functional states. Those states are herein referred to as the extended state and the retracted state.

In an embodiment, the adapter and spout have a vaned structure similar to a wine stopper. The invention is manually pressed into the bottle opening. The invention includes at least one vane made of a flexible material. As an example, the entire structure is made of one material, and the flexible vane is made with a thinner use of the one material. In a second example, two materials are used. The body of this embodiment has a hollow neck and a valve. As an example, a spout is formed at the top of the embodiment; below the spout is a standoff section to limit travel into the bottle; a flow control valve is located inside the body; and a detail uses a vent tube attached to the bottom of the body to make an air connection between the inside of the body and the bottom area of the bottle.

In an embodiment, a cap adapter is used. The cap adapter screws or is manually pressed onto the open bottle. The cap adapter has a generally rigid polymeric body that is similar to the original bottle cap, having a similar size and shape with internal threads. The cap adapter has a flexible section in the portion that covers the bottle opening. As an example, the flexible section is round; the flexible section incorporates the flow control when used without an adapter; the flexible section receives the adapter when an adapter is used; the adapters have an extended drink tube that is pushed through the flexible section; and the drink tube is perforated to allow the bottle to be completely emptied.

In an embodiment, the adapter and spout include a nipple made of one flexible material and is designed to have three functional states (orientations, configurations, or positions). The invention is pressed onto the bottle opening. The invention is intended to hold its position in each of the functional states. The user is to change states by pushing on the nipple tip in a direction toward the bottom of the invention. The invention cycles from an expanded position, to a collapsed position and then to an inverted position.

In the expanded state, the invention can be pushed or threaded onto a bottle opening. The flexible material seals the invention to the bottle opening. In the expanded state, the invention is ready for a user to drink through it. In the expanded state, the nipple is extended.

In the collapsed state, the invention is collapsed into a disc shape. The collapsed state is intended to provide packing efficiency when many units of the invention are desired.

The third state is the inverted state. The inverted device is ready for cleaning, having been turned inside out, thus exposing any internal corners to the outside. In the inverted state, the nipple is extended again but is now inside out.

In an embodiment, a resilient balloon adapter is disclosed. The embodiment is made of a flexible material such as rubber or a polymer. As an example, the adapter is screwed or pressed onto the bottle opening; the material incorporates the flow control; the flow control allows use with or without an adapter; and the flow control receives the adapter as in other embodiments.

### BRIEF DESCRIPTION OF THE SEVERAL DRAWINGS

Drawings of the various embodiments is included with this specification to provide an exemplary description.

FIG. 1 Demonstration of an exemplary embodiment of a hygienic bottle spout that reuses the original cap.

FIG. 2 Demonstration of an exemplary embodiment of a hygienic bottle spout with an invertible spout.

FIG. 3 Demonstration of an exemplary embodiment of a hygienic bottle spout with a wine stopper arrangement.

FIG. 4 Demonstration of an exemplary embodiment of a hygienic bottle spout with a two-part puncture seal, tube and nipple arrangement.

FIG. 5 Demonstration of an exemplary embodiment of a hygienic bottle spout with a 3-state nipple adapter arrangement.

FIG. 6 Demonstration of an exemplary embodiment of a hygienic bottle spout with a resilient balloon adapter.

FIG. 7 Demonstration of an exemplary embodiment of a duck bill type valve.

### DETAILED DESCRIPTION OF THE DRAWINGS

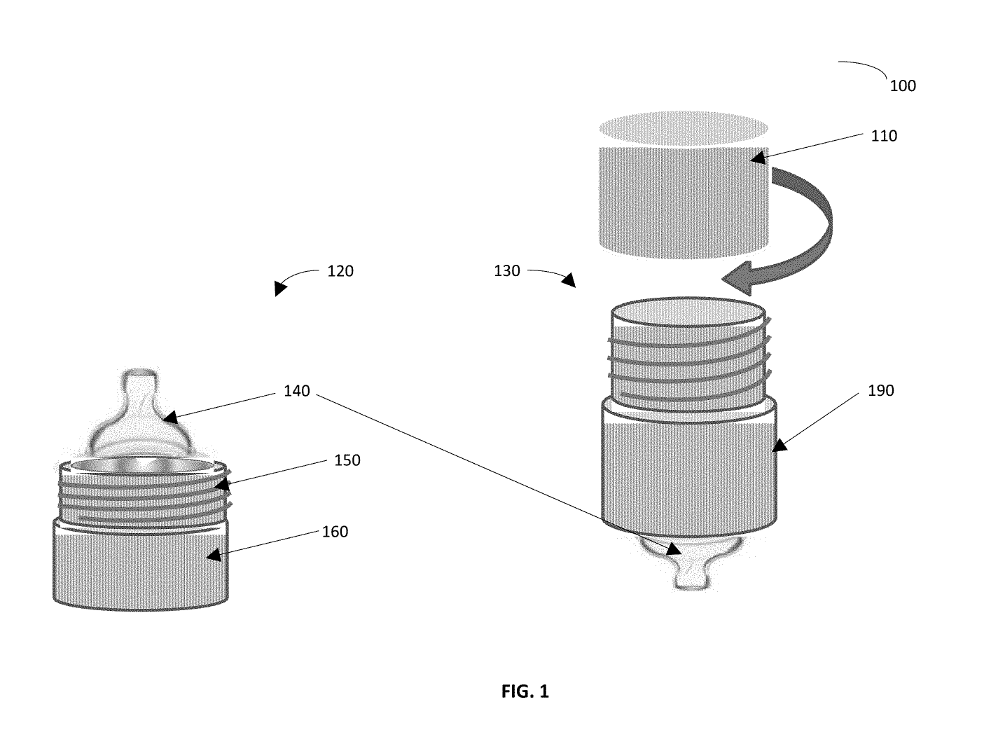

In FIG. 1 100 is an assembly drawing demonstration of an exemplary embodiment of a hygienic bottle spout that reuses the 110 original cap. 120 demonstrates the bottle spout assembly with the 140 flexible polymeric or rubber nipple extended and projecting above the bottle spout. 130 demonstrates the bottle spout assembly with the 140 nipple inverted. With the 140 nipple inverted, the 110 cap can be screwed onto the bottle spout over the outer threads of the 150 upper body of the bottle spout assembly. In turn, the hard plastic 160 lower body of the bottle spout assembly has internal threads that fit a standard bottle, and is screwed onto the standard bottle opening. This embodiment reuses the bottle cap and inverts to improve cleanability. 190 illustrates the visible outside location where there are internal corner locations that must meet the 0.75T radial requirement, here where the nipple is attached to the inside of the body of the spout.

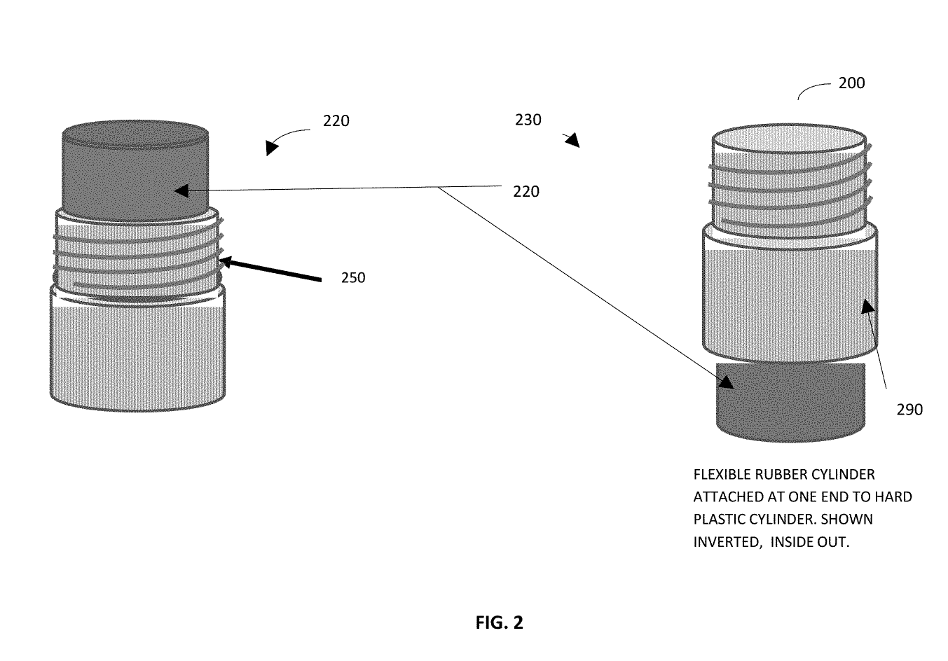

In FIG. 2 is a demonstration of an exemplary embodiment of a hygienic bottle spout with a 220 flexible, invertible, cover—type nipple that reuses an original bottle cap. 220 demonstrates the assembly of the bottle spout with the 220 nipple extended above the assembly. 230 demonstrates the assembly of the bottle spout with the 220 nipple inverted below the assembly, thus allowing the use of a bottle cap. The 250 spout body has an upper external threaded portion and a lower internal threaded portion. 220 also has one or more slits cut through it and above the bottle opening to allow a flow between the inside and outside of the bottle. 290 illustrates the visible outside location where there are internal corner locations that must meet the 0.75T radial requirement, here where the nipple is attached to the inside of the body of the spout.

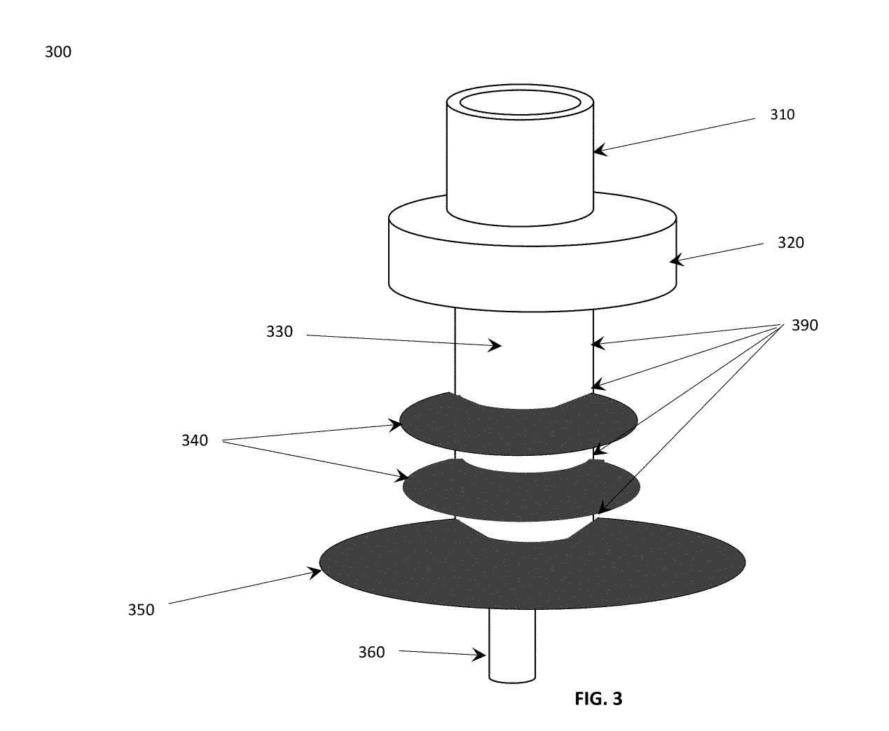

FIG. 3 Assembly 300 demonstrates an exemplary embodiment of a hygienic bottle spout with a wine stopper arrangement. 310 is a mouth interface, spout opening. 320 is a rigid standoff section to limit travel the bottle spout into the bottle. 330 demonstrates a hollow neck that contains a valve. 340 demonstrates 2 flexible vanes. 350 demonstrates a larger vane, to retain the inserted portion of the bottle spout assembly inside the bottle. 360 demonstrates an intake or vent tube that can have a length near the bottom of the bottle to assist in the flow of air back into the bottle. 390 illustrates the visible outside locations where there are internal corner locations that must meet the 0.75T radial requirement. Here, this is where the vanes attach to the body of the assembly and where the vent tube connects to the body; also inside where the 330 valve is connected to the body, above and below the valve.

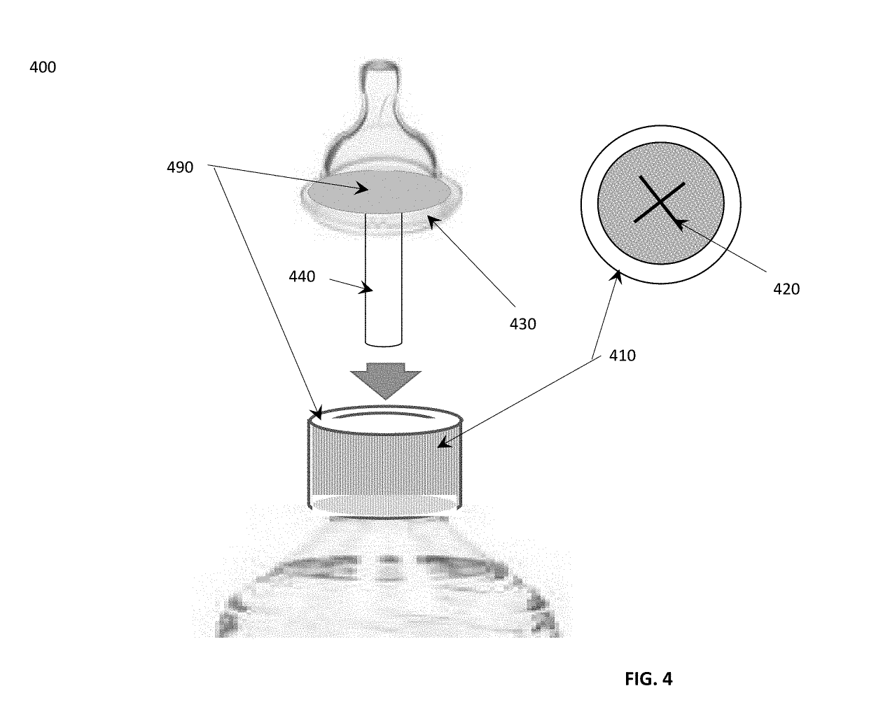

FIG. 4 Demonstration of an exemplary embodiment of a hygienic bottle spout with a three-part puncture seal, tube and nipple arrangement. The 410 flexible rubber or polymer cap fits over the top of a bottle. The 420 slits demonstrate the opening through which 440 tube is pierced, but also demonstrates the normally closed, sealing position. 430 nipple is integrated or separable from the 440 tube. 450 is the assembly view of the 410 flexible cap shown on the bottle—ready to receive the 440 tube. 490 illustrates the visible outside locations where there are internal corner locations that must meet the 0.75T radial requirement. Here, this is where the 440 cap has internal, circumferential corner between the cylindrical portion and its flat top portion.

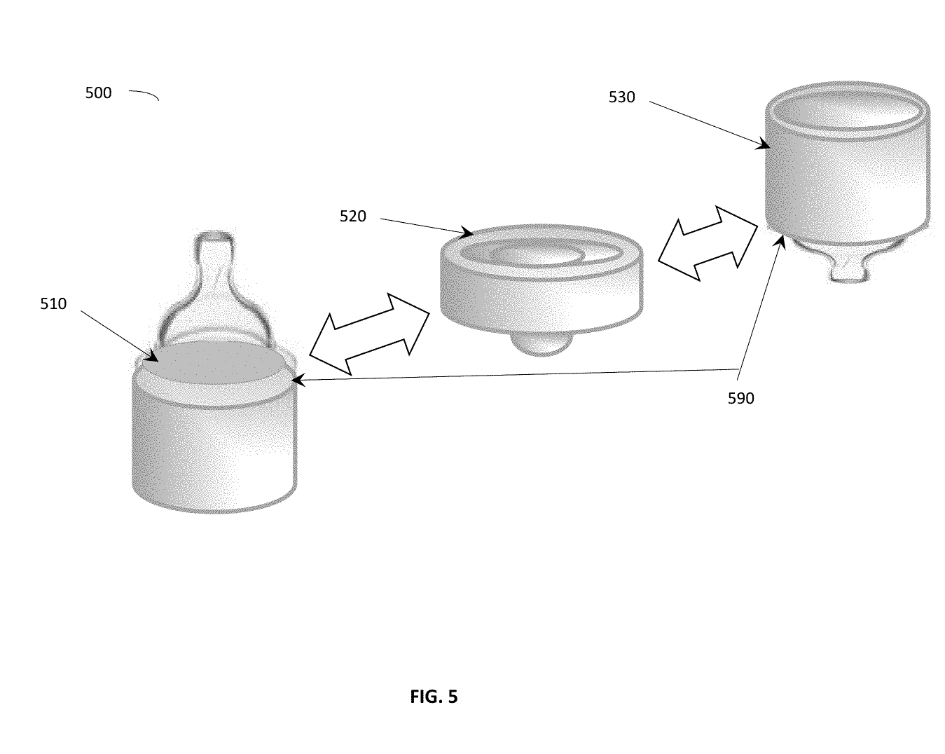

FIG. 5, the 500 assembly demonstration of an exemplary embodiment of a hygienic bottle spout with a 3-state nipple adapter arrangement. The first state 510 extended assembly is the “ready to drink” state. The second state 520 assembly is collapsed and appropriate for packaging or storage. The third state 530 assembly is inverted and ready for cleaning by exposing the inside of the nipple to the outside. All components can be of one material, and would press or thread onto a standard bottle top, in the first state. 590 illustrates the visible outside locations where there are internal corner locations that must meet the 0.75T radial requirement. Here, where the flexible nipple section meets the cylindrical body, at least when in the inverted position but preferably when in either of the three positions.

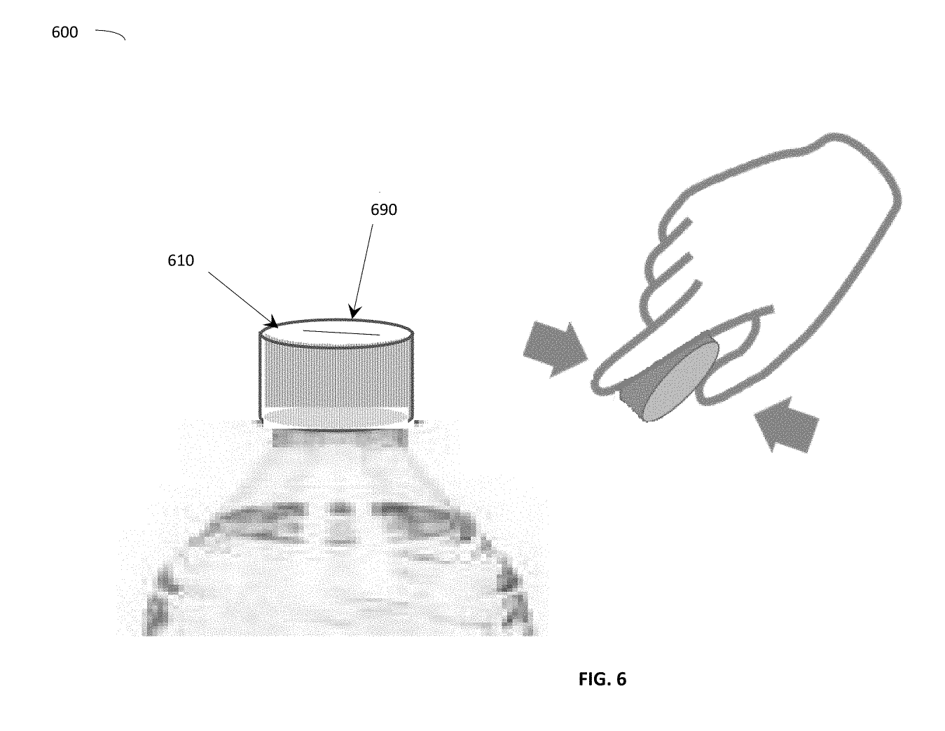

FIG. 6 Demonstration of an exemplary embodiment of a hygienic bottle spout with a resilient balloon adapter. 610 is a single piece sized to fit over a standard bottle opening with an elastic interference fit, like a glove. The single piece spout is flexible, made of rubber or polymer. The single piece may be inverted to expose the interior of the spout, for easy cleaning. The hand demonstrates that the spout is flexible. 690 illustrates the visible outside locations where there are internal corner locations that must meet the 0.75T radial requirement. Here, this is where the 440 cap has internal, circumferential corner between the cylindrical portion and its flat top portion.

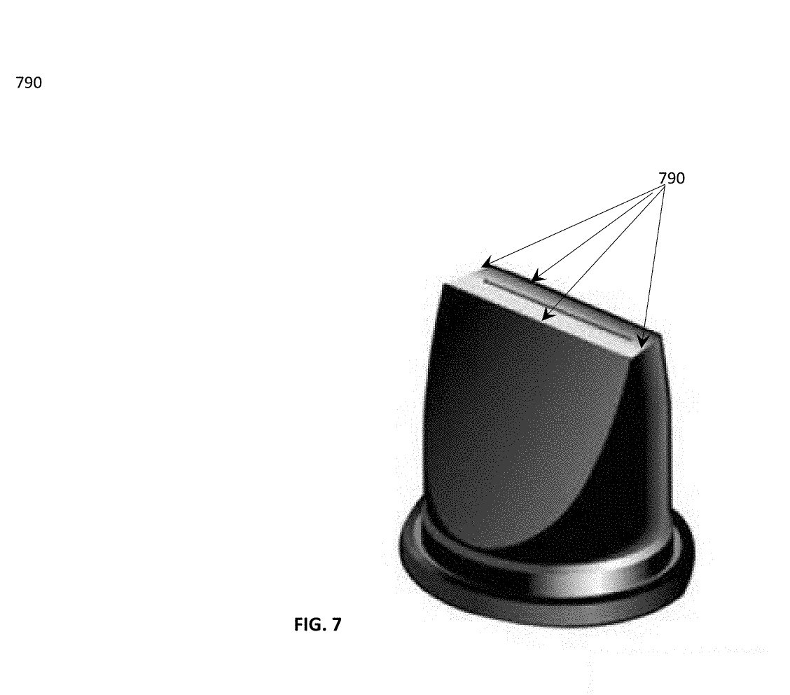

FIG. 7 Demonstration of an exemplary embodiment of a duck bill type valve. 790 illustrates the visible outside locations where there are internal corner locations that must meet the 0.75T radial requirement. Here, this is especially important at the corners along the 4 edges of the valve, and where the valve outer perimeter attaches to a spout assembly body.

FIG. 8 Demonstrates an embodiment of the spout.

I claim:

1. A drinking spout having form that limits the internal radii at all formed corners such that all interior surfaces are readily washable, and attaches to a typical bottle opening, while sealing the attachment point, and
introduces an opening for a flow from inside the bottle and out through a nipple drinking detail that interfaces with a user's mouth,
furthermore being made of flexible materials and is manually pressed over the threads of the bottle opening, further having details to retain to the spout to the opening with an interference fit over the bottle threads.

2. The drinking spout of claim 1 wherein the radius of any internal corner is 0.75 times the thickness of the material with which the spout is made.

3. The drinking spout of claim 1 having a flow control detail to reduce spillage such as but not limited to a pliable, normally closed but vacuum or fluid pressure opened valve at either one of the two ends of the spout, and a large top opening such that the interior of the spout on the valve end is readily washable and the interior of the opening is readily washable.

4. The drinking spout of claim 1 having an adapter, tube and spout configuration wherein the three components can be molded and adhered as a single unit, or are separable;
the three components include a flexible bodied adapter that fits over the bottle opening, a tubular insert to pierce the top of the adapter, and a spout at the top of the tubular insert, thus creating an opening between inside and outside of the bottle,
further, said adapters physically secure to the bottle opening with an interference fit and can be threaded or secured with an interference fit,
flow control is provided by linear openings in the portion of the adapter that rests over the opening, said linear openings unflex to a closed position and form a seal when a tubular insert is not inserted, said adapters can be used without the tubular insert by squeezing or sucking on the bottle,
said tubular inserts can be used without a spout attached, tubular inserts also have external retention details with interference fits to the adapter,
further said spouts physically contact the user's mouth and are any of the type including but not limited to flip up spouts, straws, bottle nipples, baby nipples, wide spouts, twist to open spouts, and others having a generally hollow design that allows fluid to pass from the bottle and generally to the user.

5. The drinking spout in claim 1 wherein the materials used are made with materials impregnated with substances that reduce the propensity to grow contaminants, such but not limited to antimicrobial, antibacterial, and disinfecting substances.

6. The drinking spout in claim 1 wherein an invertible nipple and body are used as a single piece or as two attached components,
the nipple being made of a pliable material such as rubber, and formed such that when the nipple is inverted from an extended orientation, any sharp corners that are made by the nipple in an extended orientation are exposed by the inversion; furthermore, outer corners and forms are made such that sharp corners are not created by the inversion, thus allowing all internal surfaces of the device to be more readily cleaned.

7. The drinking spout in claim 1 wherein the adapter and spout are sealed using an original bottle cap, whereby the adapter has internal threads that fit onto and seal the bottle opening, a rigid, tubular center section and external threads to receive the original bottle cap; and
the spout formed as a nipple made of flexible material with an extended and a retracted orientation such that the nipple holds its position in each of the two functional states.

8. The drinking spout in claim 1 having an adapter and spout with an extended and vaned structure that is manually pushed inside the bottle through the bottle opening;
having one or more vanes made of flexible materials and aligned along the center axis of the drinking spout;
creating an interference and sealing fit between the inside of the bottle and the at least one vane.

9. The drinking spout in claim 1 wherein the assembly has external and internal threads on first and second, opposite ends of a short, cylindrical spout body;
at the first end, external threads are present at a size sufficient to fit and are manually rotated and threaded to secure to the inside of a standard, threaded bottle cap;
and at the second end, internal threads are present at size sufficient to fit and manually rotated and threaded to secure to the outside of a standard bottle opening.

10. The drinking spout in claim 1 wherein the adapter and spout include a nipple and are made of one flexible material, the spout having three stable, functional states of extended, collapsed and inverted; furthermore, the functional states being achieved by a user pushing along the center axis in either direction;
in the extended state the spout is sized at one end to be manually pressed or threaded onto the bottle opening;
in the collapsed state the spout has a generally planar, disc shape;
in the inverted state, the inverted device is ready for cleaning, having been turned inside out, thus exposing any internal corners to the outside.

11. The drinking spout in claim 1 having two separate components, those being a cover and an inserted nipple; wherein the cover is made of a single, flexible material such as rubber or a polymer, and is manually screwed or pressed onto a standard sized bottle opening; the cover having linear slits to provide both a flow control when used without a nipple adapter and providing a clearance hole to receive a nipple adapter; the flow control allows use with or without an inserted nipple; the nipple being hollow, generally rigid and having a mouth interface at one end and a tubular shape at the other end, and the tubular end of the nipple is manually inserted through the cap linear slits to create a fluid path between the inside of the bottle, through the spout and to the outside and user.
